(19) United States
(12) Patent Application Publication
(10) Pub. No.: US 2025/0167840 A1
(43) Pub. Date: May 22, 2025

(54) Multi-port DL Receiver UE Capability

(71) Applicant: Parallel Wireless, Inc., Nashua, NH (US)

(72) Inventors: Yaniv Kaver, Kefar Seva (IL); Ory Eger, Tel Aviv (IL)

(21) Appl. No.: 18/951,641

(22) Filed: Nov. 18, 2024

Related U.S. Application Data
(60) Provisional application No. 63/600,462, filed on Nov. 17, 2023.

(51) Int. Cl. H04B 7/0452; H04L 25/02

(52) U.S. Cl. CPC H04B 7/0452; H04L 25/0202

(57) ABSTRACT

A method is disclosed for enhancing the performance of a Multi-User Multiple Input Multiple Output (MU-MIMO) system, comprising: measuring, by a User Equipment (UE), a plurality of ports including dedicated ports and additional ports beyond the dedicated ports; characterizing, by the UE, interfering streams based on the measurements of the additional ports; and sending, from the UE, a message to a gNB to relax stream separation requirements, thereby increasing cell throughput and efficiency.

### CROSS-REFERENCE TO RELATED APPLICATIONS

The present application claims priority under 35 U.S.C. § 119 (e) to U.S. Provisional Patent Application No. 63/600,462, filed Nov. 17, 2023 and having the same title as the present application, which application is hereby incorporated by reference in its entirety for all purposes.

This application also hereby incorporates by reference, for all purposes, each of the following U.S. patent application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; US20170257133A1; and US20200128414A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1, US20200128414A1, US20230019380A1 in their entirety. Features and characteristics of and pertaining to the systems and methods described in the present disclosure, including details of the multi-RAT nodes and the gateway described herein, are provided in the documents incorporated by reference. This document also hereby incorporates by reference in its entirety 3GPP TS 38.331 17.6.0.

### BACKGROUND

MU-MIMO (Multi-User Multiple Input Multiple Output) is a method used in wireless communication to multiplex multiple user equipment (UEs) over the same frequency and time resource by utilizing spatial diversity. Regular MIMO transceivers can handle a small number of layers, such as four, while massive MIMO, with large adaptive antenna arrays, can handle a larger number of layers, such as sixteen. Each UE is sent one or more streams out of the total available streams, allowing for efficient use of the available bandwidth and improved overall system performance.

### SUMMARY

A method is disclosed for enhancing the performance of a Multi-User Multiple Input Multiple Output (MU-MIMO) system, comprising: measuring, by a User Equipment (UE), a plurality of ports including dedicated ports and additional ports beyond the dedicated ports; characterizing, by the UE, interfering streams based on the measurements of the additional ports; and sending, from the UE, a message to a gNB to relax stream separation requirements, thereby increasing cell throughput and efficiency.

The method may further comprise performing, at the UE, channel estimation based on the measurements of the additional ports. The method may further comprise combining, by the UE, receive antennas in a manner that mitigates the interfering streams and optimizes the performance of the dedicated ports. The method may further comprise conveying, by the UE, a Multi-port Downlink (DL) Receiver capability to a next-generation Node B (gNB), The capability information may include a bit indicating the presence of the Multi-port DL Receiver capability and a number indicating a total number of ports the UE can measure. The method may further comprise modifying, by the gNB, a beamforming algorithm based on the Multi-port DL Receiver capability of the UE to relax stream separation requirements, thereby increasing cell throughput and efficiency. The measuring of the plurality of ports by the User Equipment (UE) may include measuring Demodulation Reference Signals (DMRS) symbols in the Physical Downlink Shared Channel (PDSCH) or Physical Uplink Shared Channel (PUSCH) signals for channel estimation. The separation of the ports may be achieved using Code Division Multiplexing (CDM) with Orthogonal Cover Codes (OCC) in time and frequency. The next-generation Node B (gNB) modifies its beamforming algorithm based on the Multi-port Downlink (DL) Receiver capability of the User Equipment (UE) to relax stream separation requirements. The capability information conveyed by the User Equipment (UE) may include a bit indicating the presence of the Multi-port Downlink (DL) Receiver capability and a number indicating the total number of ports the UE can measure. The method may further comprise using the capability information as part of the standard or generating a test signal to indicate if a User Equipment (UE) may be using the Multi-port Downlink (DL) Receiver based on its performance. The MU-MIMO system may be at least one of an LTE-compatible network, a UMTS-compatible network, and a 5G network.

In a second embodiment, a non-transitory computer-readable medium may be disclosed containing instructions which, when executed on a processor in a cellular network system, causes the processor to perform the steps of the above method.

### BRIEF DESCRIPTION OF THE DRAWINGS

FIG. 1 is a schematic diagram showing beamforming interference, in accordance with some embodiments.

FIG. 2 is a schematic diagram showing DMRS ports, in accordance with some embodiments.

FIG. 3 is a block diagram showing channel estimation only on dedicated ports, in accordance with the prior art.

FIG. 4 is a block diagram showing channel estimation on dedicated ports and also on other measured ports, in accordance with some embodiments.

FIG. 5 is a schematic diagram of a multi-RAT ORAN-compatible deployment architecture, in accordance with some embodiments.

FIG. 6 is a further schematic diagram of a multi-RAT ORAN-compatible deployment architecture, in accordance with some embodiments.

### DETAILED DESCRIPTION

### MU-MIMO

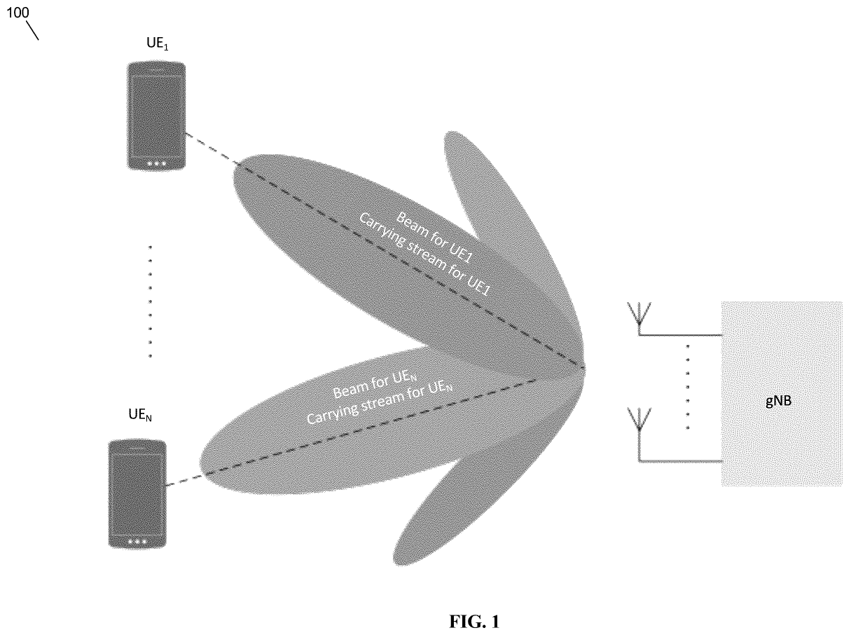

MU-MIMO (Multi-User Multiple Input Multiple Output) is a method of multiplexing UEs over the same frequency and time resource by utilizing space diversity (spatial diversity). Regular MIMO transceivers can handle a small number of layers, such as four. Massive MIMO, with large adaptive antenna arrays, can handle a larger number of layers, such as sixteen. Each UE will be sent one or more streams out of the total available streams. FIG. 1 is a schematic diagram showing beamforming interference, in accordance with some embodiments; the diagram schematically shows a gNB with MU-MIMO support directing a beam toward a first UE, UE1, and directing a second beam toward another UE, UEN, each beam carrying different data streams and each beam being directed using spatial diversity using the multiple antennas at the gNB.

### DMRS Ports

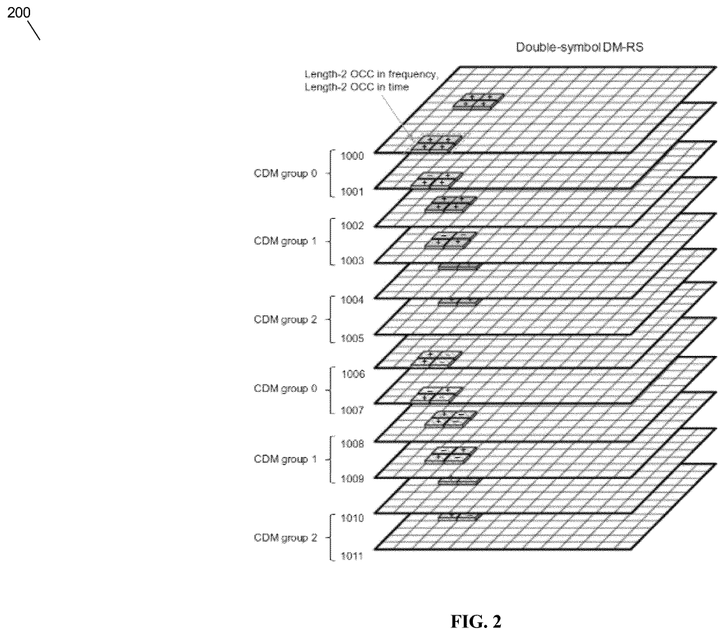

FIG. 2 is a schematic diagram showing DMRS ports, in accordance with some embodiments. In the figure, which is representative of some embodiments, a demodulation reference signal type 2 supports twelve ports.

DMRS (Demodulation Reference Signals) symbols are included in the PDSCH (Physical Downlink Shared Channel) or PUSCH (Physical Uplink Shared Channel) signals and are used for channel estimation. To separate between the DMRSs for each (single user) SU-MIMO or (multi-user) MU-MIMO stream, a different port configuration is used. In the 3GPP standard, the largest number of ports supported is twelve. More ports can be supported “above spec,” assuming beamforming is done so that some ports do not interfere with other ports due to strong spatial separation.

The ports are typically separated in two ways: Code Division Multiplexing (CDM) using Orthogonal Cover Codes (OCC) in time and frequency, and combs in frequency. In UL, the gNb performs channel estimation on all occupied PUSCH ports. However, in DL, the UE usually performs channel estimation only on its dedicated PDSCH ports and does not look at the others. While these are the typical ways ports are distinguished and separated, other methods may be used and the present disclosure is compatible with other ways of separating ports, as long as the receiver is configured to characterize other ports beyond certain identified or dedicated ports.

### Problem Definition—Suboptimal Demodulation

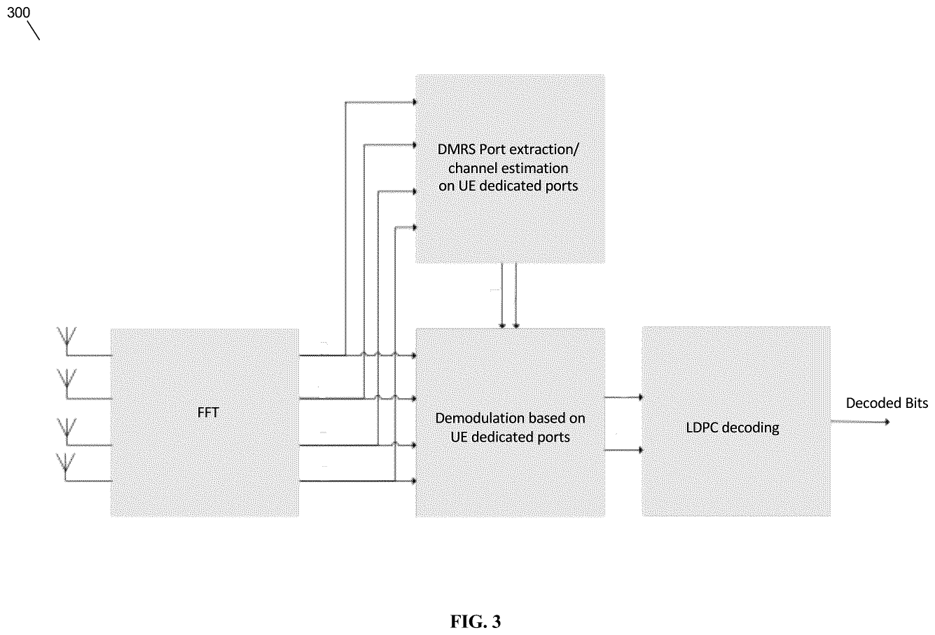

It is noted by the inventors that UE receivers typically only perform channel estimation on their dedicated ports. As a result, if there is interference on a particular dedicated port, the UE will not be able to fully handle interference from other ports, leading to suboptimal performance. This is shown in FIG. 3, which is a block diagram showing channel estimation only on dedicated ports.

### Solution—Multi-Port DL Receiver UE Capability

In some embodiments, the proposed solution involves the UE measuring some of the other UE's ports in addition to its dedicated ports. This capability allows the UE to characterize the interfering streams, such as by direction or frequency, or such as by determining a matrix characterizing the interfering streams using known channel estimation methods. Having characterized the interfering streams, the UE can then combine its Rx (receive) antennas in a way that mitigates these streams and maximizes the UE dedicated streams. Additional system performance gain can be achieved if the UE informs the gNB that it has the presently described Multi-port DL (downlink) Receiver Capability via a control channel.

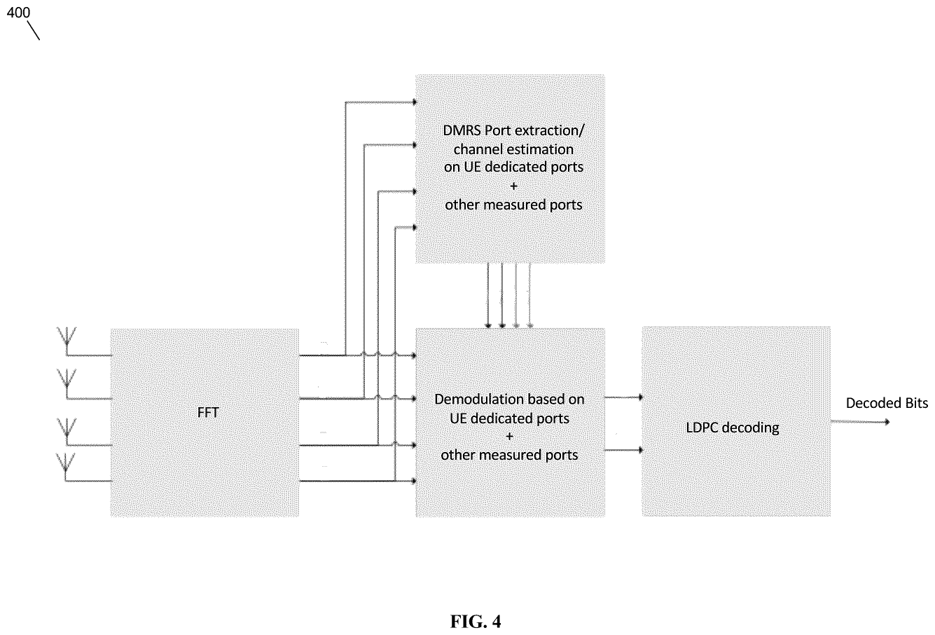

FIG. 4 is a block diagram showing channel estimation on dedicated ports and also on other measured ports, in accordance with some embodiments. Notably, after signal Rx and FFT, DMRS port extraction and channel estimation is performed not only on dedicated ports (e.g., UE dedicated ports) but also on other measured ports, and, once port extraction and channel estimation is performed, the output is sent to the demodulating step so that demodulation can be based on dedicated ports and also on other measured ports. In some embodiments, channel estimation results in the construction of a channel estimation matrix ([H]) for each of the extra measured ports and these are shared with the demodulation module. The demodulation step is thus enabled to use the additional channel estimates.

### Applications and Benefits

In some embodiments, beamforming at the gNB is not always ideal due to reasons such as stale channel information, high antenna correlation, and channel conditions. Hence, the beams used for the UE dedicated streams may also include high interference from other UEs' beams. In these cases, a UE using a Multi-port DL Receiver would be able to use algorithms that analyze the other streams and minimize their interference. Additionally, if a gNb knows that the UE has Multi-port DL Receiver capabilities and how many ports it can measure, it can modify its beamforming algorithm and relax its stream separation requirements. This will result in more users being scheduled together and achieving higher cell throughput and efficiency.

### Protocol Aspects

In some embodiments, the new Multi-port DL Receiver UE capability will need to be conveyed from the UE to the gNB. There can be two formats for this capability: a bit indicating if the UE has or does not have Multi-port DL Receiver capability, and a number indicating how many total ports the UE can measure. This information can be conveyed over capability information and described in 3GPP TS 38.331. This information can be shared with the gNB, in some embodiments, or with the near-RT RIC or non-RT RIC, in some embodiments, with a near-RT RIC sending instructions to the gNB to modify its beamforming algorithm.

### System Aspects

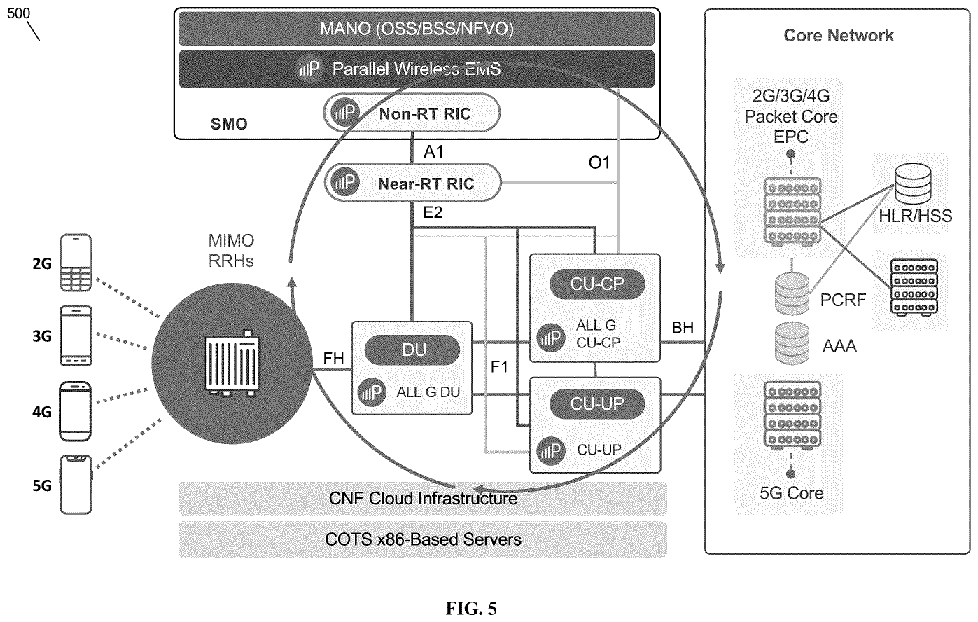

FIG. 5 is a schematic diagram of a multi-RAT OpenRAN-compatible deployment architecture, in accordance with some embodiments. Open Radio Access Network (Open RAN) is a movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Open RAN has published specifications for the 4G and 5G radio access technologies (RATs). Here, an OpenRAN-compatible deployment architecture is shown. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

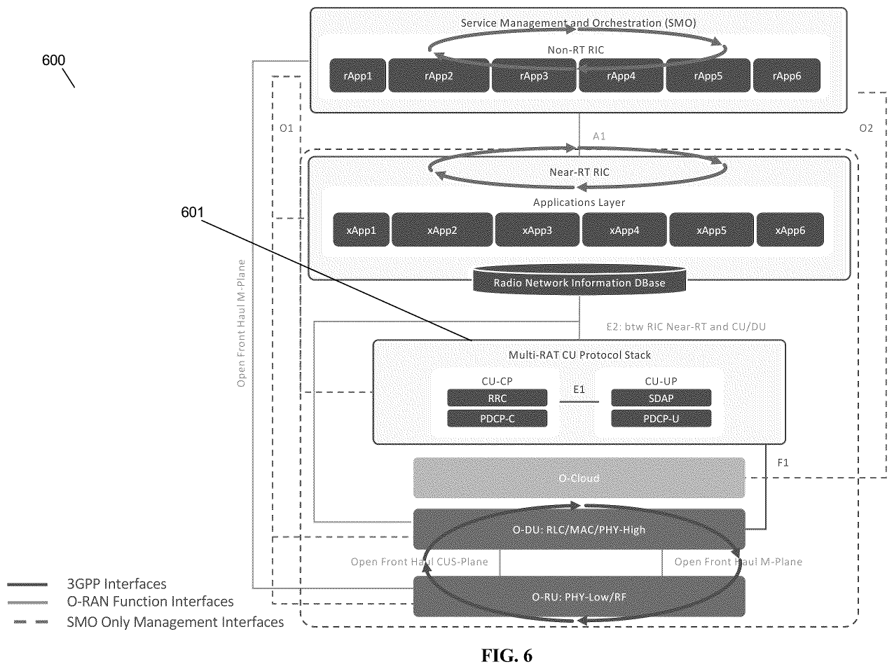

FIG. 6 is a further schematic diagram of a multi-RAT RAN deployment architecture, in accordance with some embodiments. The multi-RAT CU protocol stack 701 is configured as shown and enables a multi-RAT CU-CP and multi-RAT CU-UP, performing RRC, PDCP, and SDAP for all-G. As well, some portion of the base station (DU or CU) may be in the cloud or on COTS hardware (O-Cloud), as shown. Coordination with SMO and the all-G near-RT RIC and the all-G non-RT RIC may be performed using the A1 and O2 function interfaces, as shown and elsewhere as specified by the ORAN and 3GPP interfaces for 4G/5G.

### Alternatives and Equivalents

In some embodiments, generating a test signal can indicate if a UE is using Multi-port DL Receiver based on its performance.

MU-MIMO is also a capability of some 4G LTE base stations, and where 5G and a 5G architecture are described herein, the present disclosure is understood as being capable for being adapted to 4G MU-MIMO, in some embodiments.

The present invention is contemplated for use with any M-MIMO or MU-MIMO antenna array. An exemplary antenna array for use with the present invention is found in U.S. patent application Ser. No. 18/346,186, hereby incorporated by reference in its entirety for all purposes.

The foregoing discussion describes the use of UE processing to improve downlink performance. In some embodiments, the techniques described herein can be used at the base station (gNB etc.) to improve uplink performance.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, UMTS-compatible networks, 5G networks, or networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for enhancing the performance of a Multi-User Multiple Input Multiple Output (MU-MIMO) system, comprising:
measuring, by a User Equipment (UE), a plurality of ports including dedicated ports and additional ports beyond the dedicated ports;
characterizing, by the UE, interfering streams based on the measurements of the additional ports; and
sending, from the UE, a message to a gNB to relax stream separation requirements,
thereby increasing cell throughput and efficiency.

2. The method of claim 1, further comprising performing, at the UE, channel estimation based on the measurements of the additional ports.

3. The method of claim 1, further comprising combining, by the UE, receive antennas in a manner that mitigates the interfering streams and optimizes the performance of the dedicated ports.

4. The method of claim 1, further comprising conveying, by the UE, a Multi-port Downlink (DL) Receiver capability to a next-generation Node B (gNB), wherein the capability information includes a bit indicating the presence of the Multi-port DL Receiver capability and a number indicating a total number of ports the UE can measure.

5. The method of claim 1, further comprising modifying, by the gNB, a beamforming algorithm based on the Multi-port DL Receiver capability of the UE to relax stream separation requirements, thereby increasing cell throughput and efficiency.

6. The method of claim 1, wherein the measuring of the plurality of ports by the User Equipment (UE) includes measuring Demodulation Reference Signals (DMRS) symbols in the Physical Downlink Shared Channel (PDSCH) or Physical Uplink Shared Channel (PUSCH) signals for channel estimation.

7. The method of claim 1, wherein the separation of the ports is achieved using Code Division Multiplexing (CDM) with Orthogonal Cover Codes (OCC) in time and frequency.

8. The method of claim 1, wherein the next-generation Node B (gNB) modifies its beamforming algorithm based on the Multi-port Downlink (DL) Receiver capability of the User Equipment (UE) to relax stream separation requirements.

9. The method of claim 1, wherein the capability information conveyed by the User Equipment (UE) includes a bit indicating the presence of the Multi-port Downlink (DL) Receiver capability and a number indicating the total number of ports the UE can measure.

10. The method of claim 1, further comprising using the capability information as part of the standard or generating a test signal to indicate if a User Equipment (UE) is using the Multi-port Downlink (DL) Receiver based on its performance.

11. The method of claim 1, wherein the MU-MIMO system is at least one of an LTE-compatible network, a UMTS-compatible network, and a 5G network.

12. A non-transitory computer-readable medium containing instructions which, when executed on a processor in a cellular network system, causes the processor to perform steps comprising:
measuring, by a User Equipment (UE), a plurality of ports including dedicated ports and additional ports beyond the dedicated ports;
characterizing, by the UE, interfering streams based on the measurements of the additional ports; and
sending, from the UE, a message to a gNB to relax stream separation requirements,
thereby increasing cell throughput and efficiency.

13. The non-transitory computer-readable medium of claim 12, the instructions further comprising performing, at the UE, channel estimation based on the measurements of the additional ports.

14. The non-transitory computer-readable medium of claim 12, the instructions further comprising combining, by the UE, receive antennas in a manner that mitigates the interfering streams and optimizes the performance of the dedicated ports.

15. The non-transitory computer-readable medium of claim 12, the instructions further comprising conveying, by the UE, a Multi-port Downlink (DL) Receiver capability to a next-generation Node B (gNB), wherein the capability information includes a bit indicating the presence of the Multi-port DL Receiver capability and a number indicating a total number of ports the UE can measure.

16. The non-transitory computer-readable medium of claim 12, the instructions further comprising modifying, by the gNB, a beamforming algorithm based on the Multi-port DL Receiver capability of the UE to relax stream separation requirements, thereby increasing cell throughput and efficiency.

17. The non-transitory computer-readable medium of claim 12, wherein the measuring of the plurality of ports by the User Equipment (UE) includes measuring Demodulation Reference Signals (DMRS) symbols in the Physical Downlink Shared Channel (PDSCH) or Physical Uplink Shared Channel (PUSCH) signals for channel estimation.

18. The non-transitory computer-readable medium of claim 12, wherein the separation of the ports is achieved using Code Division Multiplexing (CDM) with Orthogonal Cover Codes (OCC) in time and frequency.

19. The non-transitory computer-readable medium of claim 12, wherein the next-generation Node B (gNB) modifies its beamforming algorithm based on the Multi-port Downlink (DL) Receiver capability of the User Equipment (UE) to relax stream separation requirements.

20. The non-transitory computer-readable medium of claim 12, wherein the capability information conveyed by the User Equipment (UE) includes a bit indicating the presence of the Multi-port Downlink (DL) Receiver capability and a number indicating the total number of ports the UE can measure.

21. The non-transitory computer-readable medium of claim 12, the instructions further comprising using the capability information as part of the standard or generating a test signal to indicate if a User Equipment (UE) is using the Multi-port Downlink (DL) Receiver based on its performance.

22. The non-transitory computer-readable medium of claim 12, wherein the MU-MIMO system is at least one of an LTE-compatible network, a UMTS-compatible network, and a 5G network.
